(19) United States
(12) Patent Application Publication
(10) Pub. No.: US 2025/0282385 A1
(43) Pub. Date: Sep. 11, 2025

(54) METHOD FOR FUNCTIONALLY IMPROVING ENVIRONMENT MODELING IN AN ASSISTANCE SYSTEM OF A VEHICLE

(71) Applicant: Robert Bosch GmbH, Stuttgart (DE)

(72) Inventors: Markus Schuetz, Tuebingen (DE); Armin Joos, Stuttgart (DE); Miriam Nienhueser, Renningen (DE)

(21) Appl. No.: 19/062,446

(22) Filed: Feb. 25, 2025

(30) Foreign Application Priority Data
Mar. 6, 2024 (DE) 10 2024 202 099.0

(51) Int. Cl. B60W 60/00

(52) U.S. Cl. CPC B60W 60/0015

(57) ABSTRACT

A method for functionally improving environment modeling in an assistance system of a vehicle. The method includes: providing calculation paths of the assistance system, wherein the calculation paths include a respective environmental detection, wherein sensor data are analyzed and merged as part of the environmental detection, wherein the sensor data result from detection by a sensor of the vehicle; ascertaining an action option for the vehicle from each of the calculation paths based on the respective environmental detection; exchanging a corresponding result of the environmental detection between the calculation paths; modifying the action option of at least one of the calculation paths based on the corresponding exchanged result of the environmental detection, wherein at least one safety requirement of the corresponding calculation path are taken into account; determining a target action option for the assistance system based on a result of the modification.

### CROSS REFERENCE

The present application claims the benefit under 35 U.S.C. § 119 of German Patent Application No. DE 10 2024 202 099.0 filed on Mar. 6, 2024, which is expressly incorporated herein by reference in its entirety.

### FIELD

The present invention relates to a method for functionally improving environment modeling in an assistance system of a vehicle. The present invention furthermore relates to a computer program, a device, and a storage medium for this purpose.

### BACKGROUND INFORMATION

The correct detection of the environment with all relevant road users, obstacles and limitations is an important component of a driving assistance system. Different environmental sensors are used for this purpose, such as cameras, radar sensors, lidar sensors or ultrasonic sensors. The sensors have different advantages and disadvantages due to their physical properties, their installation location, their different algorithms or aging. Therefore, multiple, sometimes different, sensors are usually used in current assistance systems. A merging algorithm based thereon combines the sensor data, taking into account the different advantages and disadvantages of the sensors, with the aim of creating the most error-free representation possible of the real environment with all relevant object properties. In the context of the present invention, such a combination is called environmental detection. The requirements for the environmental detection increase with the complexity of the automated driving system in terms of functional safety (FuSa) and the safety of the intended function (SOTIF). For higher levels of automation, various implementations are often provided to meet the safety requirements, including the merging algorithm mentioned above. In various related-art approaches, multiple paths are provided, but the paths are kept completely separate. This can, for example, lead to errors with the same cause.

### SUMMARY

The present invention provides a method, a computer program, a device, and a computer-readable storage medium. Features and details of the present invention can be found in the disclosure herein. Features and details that are described in connection with the method according to the present invention of course also apply in connection with the computer program according to the present invention, the device according to the present invention, and the computer-readable storage medium according to the present invention, and vice versa in each case, so that mutual reference can also always be made with respect to the disclosure of the present invention.

According to an example embodiment of the present invention a method for functionally improving environment modeling in an assistance system of a vehicle, includes the following steps, wherein the steps can be carried out repeatedly and/or successively. The assistance system is in particular a multi-path assistance system, i.e., an assistance system that has at least two redundant calculation paths. The assistance system can be designed for at least partially automated control of the vehicle or provision of at least one vehicle function and can, for example, use a processor for calculation and have various software modules for this purpose.

In a first step, preferably at least two calculation paths of the assistance system are provided. The at least two calculation paths are in particular two redundant calculation paths and provide the same vehicle function for the vehicle, for example a control or a distance control. The calculation paths in particular each comprise an environmental detection, wherein sensor data are analyzed and merged as part of the environmental detection. When the sensor data are merged, a representation of the environment of the vehicle is generated, in particular on the basis of the analyzed sensor data. The sensor data preferably result from detection by at least one sensor of the vehicle. The at least one sensor can, for example, be a camera, a radar sensor, an ultrasonic sensor and/or a LiDAR sensor.

In a further step, preferably at least one action option for the vehicle is ascertained from each of the at least two calculation paths on the basis of the respective environmental detection. The action option comprises in particular a specific control of the vehicle or a manner in which a vehicle function is carried out, for example values for parameters of the vehicle function. The environmental detection is taken into account or used as a basis, for example, in that the vehicle is to be steered on the basis of the action option into a free space, which is ascertained on the basis of the environmental detection.

In a further step, a corresponding result of the environmental detection is preferably exchanged between the corresponding calculation paths. In particular, a one-sided exchange can also be provided so that only one calculation path makes the corresponding result of the environmental detection available to the at least one other calculation path. It is also possible for each calculation path to make its particular result of the environmental detection available to all other calculation paths. The exchange can, for example, be a data exchange between corresponding software modules. The result of the environmental detection can, for example, be a representation of the environment generated on the basis of the merging of the analyzed sensor data.

In a further step, the at least one action option of at least one of the calculation paths is preferably modified on the basis of the corresponding exchanged result of the environmental detection, wherein at least one safety requirement, in particular all safety requirements, of the corresponding calculation path are taken into account in order to provide the functional improvement in the environment modeling in the assistance system. The safety requirement can, for example, be a distance from a preceding vehicle or a distance from a guardrail or compliance with a speed limit. The modification can, for example, be an adjustment of parameter values of a vehicle function, in particular an adjustment of a trajectory if the action option is implemented as a trajectory. Furthermore, as part of the modification, an acceleration process or braking process of the vehicle can be varied, for example. At the end of the modification, the at least one action option can be validated, wherein it is ascertained and indicated whether the at least one action option satisfies the at least one safety requirement, in particular all safety requirements.

In a further step, a target action option for the assistance system is preferably determined on the basis of a result of the modification. The result of the modification can indicate, for example, an action option validated with regard to the at least one safety requirement. While the target action option is determined, a balance can also be struck between at least two action options, and one of the at least two action options can be selected taking into account the at least one safety requirement.

According to an example embodiment of the present invention, it can be further advantageously provided for one of the at least two calculation paths to be a main path and the at least one further calculation path to be an auxiliary path, wherein the main path is used with priority for controlling the vehicle. The auxiliary path is therefore in particular a substitute path, which can be used, for example, if an error is detected in the main path. In this case, the exchange is preferably carried out from the at least one auxiliary path to the main path, in particular exclusively from the at least one auxiliary path to the main path. In an alternative, the exchange may be carried out from the main path to the at least one auxiliary path if an error is detected in the main path.

It is also advantageous if the respective environmental detections of the calculation paths differ from one another with regard to processing of the sensor data and/or with regard to sensors used. Thus, in particular, there is no homogeneous redundancy between the at least two calculation paths. In this way, a database underlying the modification of the at least one action option and the determination of the target action option can advantageously be expanded since at least two calculation paths, or their respective environmental detections, are taken into account.

In a further possibility, it can be provided for the at least one action option to describe a trajectory to be driven by the vehicle. The trajectory is in particular a planned movement of the vehicle through space and may further comprise planning of an acceleration and/or a braking process of the vehicle.

Furthermore, within the scope of the present invention, it is possible for the at least two calculation paths each to process at least two data inputs, wherein a corresponding data input is provided for each environmental detection. Preferably, only one environmental detection associated with the corresponding calculation path is used to ascertain the at least one action option for the vehicle. In this way, the at least one action option can advantageously be independently ascertained first by the at least two calculation paths.

According to an example embodiment of the present invention, it is furthermore advantageous if, within the scope of the present invention, the modification comprises the following step:
checking the at least one ascertained action option on the basis of an analysis of the exchanged corresponding result of the environmental detection, taking into account the at least one safety requirement, in particular all safety requirements, of the corresponding calculation path.

Checking can also be referred to as validation and can comprise, for example, an analysis of an ascertained trajectory, i.e., the action option, with regard to a distance from a preceding vehicle, i.e., the safety requirement.

It can be provided within the scope of the present invention for the determination to comprise the following step:
selecting one of the at least two calculation paths on the basis of a result of the check in order to determine the target action option for the assistance system using the selected calculation path.

For example, if one of the calculation paths is the main path, it can be provided for it to be selected by default. However, if an error is detected in the main path, for example on the basis of the environmental detection, the at least one further calculation path can be selected. In this case, it can be provided for the latter to use the environmental detection of the main path despite the error in the main path, taking the error into account, in order to determine the target action option for the assistance system.

It is possible for the method according to the present invention to be used in a vehicle. The vehicle can be designed, for example, as a motor vehicle and/or passenger vehicle and/or at least partially autonomous or automated vehicle. The vehicle can have a vehicle unit, for example for providing an at least partially autonomous or automated driving function and/or an assistance system. The vehicle unit may be designed to control and/or accelerate and/or brake and/or steer the vehicle at least partially automatically.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention also relates to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features mentioned herein can be essential to the present invention, individually or in any combination.

### BRIEF DESCRIPTION OF THE DRAWINGS

FIG. 1 is a schematic visualization of a method, a vehicle having an assistance system and a sensor, a device, a storage medium, and a computer program according to exemplary embodiments of the present invention.

FIG. 2 is a schematic representation of a method according to exemplary embodiments of the present invention.

### DETAILED DESCRIPTION OF EXAMPLE EMBODIMENTS

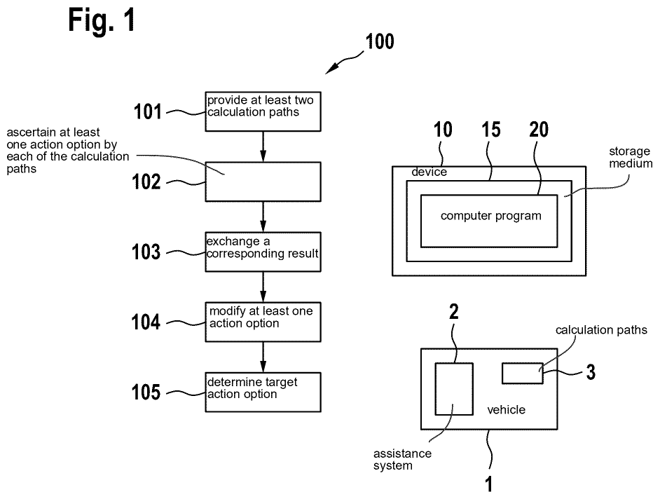

FIG. 1 schematically shows a method 100, a vehicle 1 having an assistance system 2 and a sensor 3, a device 10, a storage medium 15, and also a computer program 20 according to exemplary embodiments of the present invention.

FIG. 1 shows in particular a method 100 for functionally improving environment modeling in an assistance system 2 of a vehicle 1. In a first step 101, at least two calculation paths 3 of the assistance system 2 are provided, wherein the calculation paths 3 comprise a respective environmental detection, wherein sensor data 5a are analyzed and merged 4 as part of the environmental detection. The provision can comprise retrieval from a data memory and executing at least one software module of the assistance system 2. The sensor data 5a result from detection by at least one sensor 5 of the vehicle 1. In a second step 102, at least one action option for the vehicle 1 is ascertained by each of the at least two calculation paths 3 on the basis of the corresponding environmental detection, in particular by executing at least one software module by a processor of the assistance system 2. In a third step 103, a corresponding result of the environmental detection is exchanged between the corresponding calculation paths 3, in particular by executing at least one software module by a processor of the assistance system 2. In a fourth step 104, the at least one action option of at least one of the calculation paths 3 is modified on the basis of the corresponding exchanged result of the environmental detection, wherein at least one safety requirement, in particular all safety requirements, of the corresponding calculation path 3 are taken into account in order to provide the functional improvement in the environment modeling in the assistance system 2. This is carried out in particular by executing at least one software module by a processor of the assistance system 2. In a fifth step 105, a target action option for the assistance system 2 is determined on the basis of a result of the modification 104, in particular by executing at least one software module by a processor of the assistance system 2.

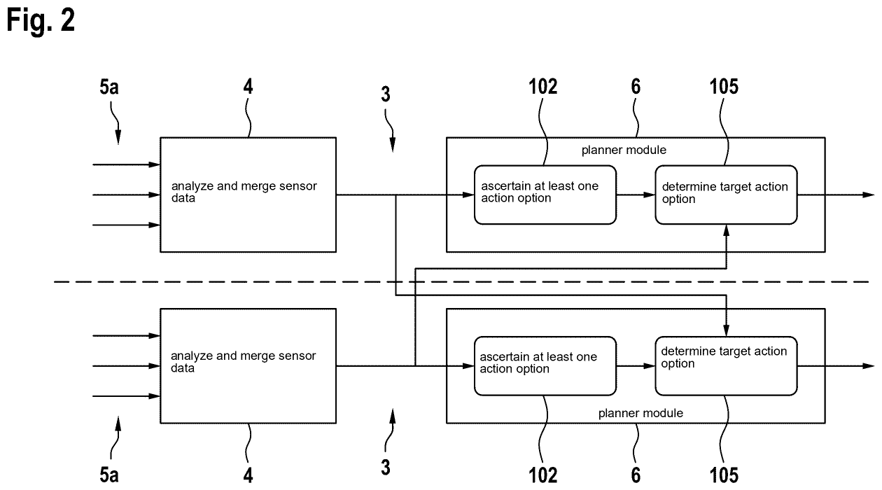

FIG. 2 schematically shows a method according to exemplary embodiments of the present invention. In each of the two calculation paths 3 shown, the environmental detection on the basis of sensor data 5a and a merging step 4 is provided first. This result of the environmental detection is exchanged between the calculation paths 3. In a further step 103, at least one action option is ascertained from each calculation path 3 by a planner module 6, wherein both environmental detections are taken into account. In a further step 105, a target action option is selected by the planner module 6. The planner module 6 can be a software module and can be executed by a processor of the assistance system 2.

According to exemplary embodiments, the present invention describes a method for combining merging approaches of calculation paths 3 or for using an alternative merging approach of a calculation path 3, for example in order to increase safety with regard to SOTIF while simultaneously avoiding common causes.

A prerequisite for the method according to exemplary embodiments is in particular a safety architecture with two functional calculation paths 3, both of which include a different environmental detection, comprising a sensor system 2 and merging 4. Such multi-path systems are already available, in particular for L3 and L4 approaches with a large range of functions.

The differences in the environmental detection can include a different sensor configuration, different processing, or both. For the SOTIF benefit, there must preferably be a certain difference, i.e., there must not be purely homogeneous redundancy. One aspect of the present invention according to exemplary embodiments is in particular a use of the results of the environmental detection from the one calculation path 3 in the other in order to reduce the frequency or risk of an incorrect response. At the same time, this can advantageously exclude errors that occur simultaneously in both calculation paths 3 so that the overall system, or the assistance system 2, is no longer operational. This ensures that an error in one calculation path 3 does not simultaneously negatively affect the other calculation path 3.

The basic requirement for the use of the method is two redundant calculation paths 3. For reasons of functional safety, this can often be the case for L3/L4 systems or vehicles 1. Even in the event of an error, continued operation should preferably be ensured until a safe state is reached. In order to exclude common cause errors, various calculation paths 3 can help. If this is the case, the method according to exemplary embodiments can be particularly advantageous. Another aspect of safety is in particular the safety of the intended function (SOTIF). In short, the system, i.e., in particular the vehicle 1, must preferably function sufficiently well to be able to cope with critical situations (in the absence of functional safety errors). In order to function sufficiently well, it may be desirable to use the results of the various environmental detections of the at least two calculation paths 3 when executing a nominal function (in normal operation).

The present invention thus provides, according to exemplary embodiments, for the results of the environmental detections of the calculation paths 3 to be made available to the other calculation path. In order to exclude common cause errors, a simple combination of the results is preferably not possible. The calculation paths 3 that use the results must therefore preferably be able to handle two inputs. The input of the own calculation path 3 preferably has priority. It alone is preferably used to ascertain at least one action option, for example by generating a trajectory bundle. The possible action options are preferably checked with the second input. Action options that are considered safe with both inputs are preferred. If, in extreme situations, no calculated action option satisfies the boundary conditions of the second input, this can be interpreted as the first sign of an error. Since the same method is carried out in parallel in the second calculation path 3, the calculation path 3 can be changed in such a case if a trajectory that is considered safe according to environmental detections has been found in the second calculation path 3.

The above description of the embodiments describes the present invention exclusively in the context of examples. Of course, individual features of the embodiments can be freely combined with one another, if technically reasonable, without departing from the scope of the present invention.

What is claimed is:

1. A method for functionally improving environment modeling in an assistance system of a vehicle, comprising the following steps:
providing at least two calculation paths of the assistance system, wherein each of the calculation paths includes a respective environmental detection, wherein sensor data are analyzed and merged as part of each respective environmental detection, wherein the sensor data result from detection by at least one sensor of the vehicle;
ascertaining at least one action option for the vehicle from each of the at least two calculation paths based on the respective environmental detection;
exchanging a corresponding result of at least one of the respective environmental detections between the respective calculation paths;
modifying the at least one action option of at least one of the at least two calculation paths based on the corresponding exchanged result of the respective environmental detection, wherein at least one safety requirement of the corresponding calculation path are taken into account to provide the functional improvement in the environment modeling in the assistance system; and
determining a target action option for the assistance system based on a result of the modification.

2. The method according to claim 1, wherein one of the at least two calculation paths is a main path, and at least one further calculation path of the at least two calculation paths is an auxiliary path, wherein the main path is used with priority for controlling the vehicle, wherein the exchange is carried out from the at least one auxiliary path to the main path.

3. The method according to claim 1, wherein the respective environmental detections of the calculation paths differ from one another with regard to processing of the sensor data and/or with regard to sensors used.

4. The method according to claim 1, wherein the at least one action option describes a trajectory to be driven by the vehicle.

5. The method according to claim 1, wherein each of the at least two calculation paths process at least two data inputs, wherein a corresponding data input is provided for each respective environmental detection, wherein only one environmental detection associated with the corresponding calculation path is used to ascertain the at least one action option for the vehicle.

6. The method according to claim 1, wherein the modification includes the following step:
checking the at least one ascertained action option on based on an analysis of the exchanged corresponding result of the respective environmental detection, taking into account the at least one safety requirement of the corresponding calculation path.

7. The method according to claim 6, wherein the determination includes the following step:
selecting a calculation path of the at least two calculation paths based on a result of the check in order to determine the target action option for the assistance system using the calculation path.

8. A device for processing data and configure to functionally improve environment modeling in an assistance system of a vehicle, the device configured to:
provide at least two calculation paths of the assistance system, wherein each of the calculation paths includes a respective environmental detection, wherein sensor data are analyzed and merged as part of each respective environmental detection, wherein the sensor data result from detection by at least one sensor of the vehicle;
ascertain at least one action option for the vehicle from each of the at least two calculation paths based on the respective environmental detection;
exchange a corresponding result of at least one of the respective environmental detections between the respective calculation paths;
modify the at least one action option of at least one of the at least two calculation paths based on the corresponding exchanged result of the respective environmental detection, wherein at least one safety requirement of the corresponding calculation path are taken into account to provide the functional improvement in the environment modeling in the assistance system; and
determine a target action option for the assistance system based on a result of the modification.

9. A non-transitory computer-readable storage medium on which are stored commands for functionally improving environment modeling in an assistance system of a vehicle, the commands, when executed by a computer, causing the computer to perform the following steps:
providing at least two calculation paths of the assistance system, wherein each of the calculation paths includes a respective environmental detection, wherein sensor data are analyzed and merged as part of each respective environmental detection, wherein the sensor data result from detection by at least one sensor of the vehicle;
ascertaining at least one action option for the vehicle from each of the at least two calculation paths based on the respective environmental detection;
exchanging a corresponding result of at least one of the respective environmental detections between the respective calculation paths;
modifying the at least one action option of at least one of the at least two calculation paths based on the corresponding exchanged result of the respective environmental detection, wherein at least one safety requirement of the corresponding calculation path are taken into account to provide the functional improvement in the environment modeling in the assistance system; and
determining a target action option for the assistance system based on a result of the modification.
